(19) United States
(12) Patent Application Publication
(10) Pub. No.: US 2026/0233783 A1
(43) Pub. Date: Aug. 13, 2026

(54) REINFORCEMENT MEMBER FOR SIDE SILL FOR VEHICLE

(71) Applicants: Hyundai Motor Company, Seoul (KR); Kia Corporation, Seoul (KR)

(72) Inventors: Young-Jun KIM, Hwaseong-si (KR); Sung-Min PARK, Hwaseong-si (KR)

(73) Assignees: Hyundai Motor Company, Seoul (KR); Kia Corporation, Seoul (KR)

(21) Appl. No.: 19/258,277

(22) Filed: Jul. 2, 2025

(30) Foreign Application Priority Data
Feb. 11, 2025 (KR) 10-2025-0017303

(51) Int. Cl. B62D 25/02; B62D 21/15

(52) U.S. Cl. CPC B62D 25/025; B62D 21/157

(57) ABSTRACT

In a side sill reinforcement member for a side sill of a vehicle according to the present disclosure, a first sub-reinforcement member and a second sub-reinforcement member are included, the first sub-reinforcement member and the second sub-reinforcement member are disposed as a plurality of members that alternate in a longitudinal direction of the vehicle, a portion of the first sub-reinforcement member is disposed above the second sub-reinforcement member, and another portion of the first sub-reinforcement member is disposed under another second sub-reinforcement member disposed in the longitudinal direction of the vehicle with respect to the second sub-reinforcement member, and the plurality of members that alternate in the longitudinal direction of the vehicle are mounted inside a side sill of the vehicle.

### CROSS-REFERENCE TO RELATED APPLICATION

This application claims priority to Korean Patent Application No. 10-2025-0017303, filed on Feb. 11, 2025, which is incorporated herein by reference in its entirety.

### BACKGROUND OF THE DISCLOSURE

### Field Of The Disclosure

The present disclosure relates to a side sill forming a structure of a lower portion of a side surface of a vehicle, and more specifically, to a side sill reinforcement member for a side sill of a vehicle, which is installed inside the side sill in a longitudinal direction of the vehicle to support a collision load input in a width direction of the vehicle.

### Description of Related Art

A side sill is configured on a lower portion of a side surface of a vehicle in a longitudinal direction of the vehicle.

As illustrated in FIG. 1, a side sill 102 includes a side sill inner 111 configured convexly inward from a vehicle and a side sill outer 112 configured convexly outward from the vehicle, and upper and lower ends of the side sill inner 111 and the side sill outer 112 are coupled to form a hollow structure in the longitudinal direction of the vehicle.

To increase the rigidity of the side sill 102, a side sill reinforcement member 120 is provided inside the side sill 102. As illustrated in FIG. 1, the side sill reinforcement member 120 is manufactured by extruding an aluminum alloy and installed inside the side sill 102, thereby improving the rigidity of the side sill 102.

A pipe nut 130 is installed in the side sill 102 to be used for mounting a battery, other components, etc. of an electric vehicle.

However, the side sill reinforcement member 120 is manufactured by extruding an aluminum alloy, resulting in an increase in the production cost of the vehicle. To assemble the side sill reinforcement member 120 configured of an aluminum alloy, a separate additional process and additional manpower are required, resulting in an increase in the production cost of the vehicle.

In addition, the side sill reinforcement member 120 configured of an aluminum alloy has a problem that assembly is not easy in a narrow cross-sectional area of the side sill 102. In vehicles with a sliding door, such as multi-purpose vehicles (MPV), a cross section of the side sill at a lower portion of the sliding door is relatively small, and it is difficult to assemble the reinforcement member configured of an aluminum alloy inside therein.

In this way, when the side sill reinforcement member 120 is not tightly assembled inside the side sill 102, an area in which paint is not coated due to a narrowed internal space of the side sill during painting, thereby causing corrosion of the side sill 102.

In particular, in the event of a side collision, the side sill 102 and the side sill reinforcement member 120 cannot support or absorb a collision load input to the side surface of the vehicle, and the side sill 102 penetrates a cabin in which occupants get on, thereby hindering a reduction in injuries to the occupants.

### SUMMARY OF THE DISCLOSURE

The present disclosure is directed to providing a side sill reinforcement member in which a plurality of sub-reinforcement members configured in a longitudinal direction of a vehicle are connected to support a collision load in the event of a side collision.

According to the present disclosure, in a side sill reinforcement member, a first sub-reinforcement member and a second sub-reinforcement member are included, the first sub-reinforcement member and the second sub-reinforcement member are disposed as a plurality of members that alternate in a longitudinal direction of the vehicle, a portion of the first sub-reinforcement member is disposed above the second sub-reinforcement member, and another portion of the first sub-reinforcement member is disposed under another second sub-reinforcement member disposed in the longitudinal direction of the vehicle with respect to the second sub-reinforcement member, and the plurality of members that alternate in the longitudinal direction of the vehicle are mounted inside a side sill of the vehicle.

A front end portion of the first sub-reinforcement member is coupled to an upper portion in the middle of the second sub-reinforcement member, and a rear end portion of the first sub-reinforcement member is coupled to a lower portion in the middle of the another second sub-reinforcement member.

The first sub-reinforcement member and the second sub-reinforcement member are repeatedly coupled in the longitudinal direction of the vehicle so that a space is repeatedly configured between the first sub-reinforcement member and the second sub-reinforcement member in the longitudinal direction of the vehicle.

The first sub-reinforcement member has a first upper surface disposed to be higher than front and rear end portions thereof, and a first lower surface disposed to be lower than the front and rear end portions and disposed at a rear of the vehicle further than the first upper surface, the second sub-reinforcement member has a second upper surface disposed to be higher than front and rear end portions thereof, and a second lower surface disposed to be lower than the front and rear end portions and disposed at the rear of the vehicle further than the second upper surface, and the first sub-reinforcement member and the second sub-reinforcement member are coupled so that the first upper surface is disposed above the second lower surface, and the second upper surface is disposed above the first lower surface.

The first sub-reinforcement member has a first front flange and a first rear flange, which extend in the longitudinal direction of the vehicle, configured at the front and rear end portions thereof, respectively, and the second sub-reinforcement member has a second front flange and a second rear flange configured at the front and rear end portions thereof, respectively, the second front flange and the second rear flange extending in the longitudinal direction of the vehicle.

The first sub-reinforcement member has a first intermediate flange configured between the first upper surface and the first lower surface, the first intermediate flange extending in the longitudinal direction of the vehicle, and the second sub-reinforcement member has a second intermediate flange configured between the second upper surface and the second lower surface, the second intermediate flange extending in the longitudinal direction of the vehicle.

The first front flange is coupled to an upper portion of the second intermediate flange, and the second front flange is coupled to an upper portion of the first intermediate flange.

The first rear flange is coupled to a lower portion of the second intermediate flange configured on the another second sub-reinforcement member, and the second rear flange is coupled to a lower portion of the first intermediate flange configured on the first sub-reinforcement member and another first sub-reinforcement member disposed in the longitudinal direction of the vehicle with respect to the first sub-reinforcement member.

A concave portion through which a pipe nut passes and which is configured to be lower than the first upper surface or the second upper surface is configured in the first upper surface or the second upper surface.

The side sill reinforcement member further includes a third sub-reinforcement member coupled to one of the first sub-reinforcement member and the second sub-reinforcement member, which is disposed at a frontmost location, at a front end portion of an assembly of the first sub-reinforcement member and the second sub-reinforcement member, and a fourth sub-reinforcement member coupled to a lower portion of a third upper surface configured on the third sub-reinforcement member.

The third sub-reinforcement member includes the third upper surface, a third lower surface disposed to be lower than the third upper surface, a third intermediate flange configured between the third upper surface and the third lower surface, a third rear flange coupled to a lower surface of a first intermediate flange of the first sub-reinforcement member or a second intermediate flange of the second sub-reinforcement member at a rear end portion of the third sub-reinforcement member, a first front joint coupled to a front pillar of the vehicle at a front end portion of the third sub-reinforcement member, and a support coupled to an inner upper surface of the side sill between the first front joint and the third upper surface.

A front flange of a sub-reinforcement member disposed at the frontmost location among the first sub-reinforcement member and the second sub-reinforcement member is coupled to an upper portion of the third intermediate flange, and the third rear flange is coupled to a lower surface of an intermediate flange of a sub-reinforcement member disposed at the frontmost location among the first sub-reinforcement member and the second sub-reinforcement member.

The fourth sub-reinforcement member includes a fourth lower surface, a second front joint disposed in front of the fourth lower surface and coupled to the first front joint, and a fourth rear flange disposed behind the fourth lower surface, extending to a rear of the vehicle, and coupled to a lower surface of the third intermediate flange.

The side sill reinforcement member further includes a fifth sub-reinforcement member coupled to one of the first sub-reinforcement member and the second sub-reinforcement member, which is disposed at a frontmost location, at a rear end portion of an assembly of the first sub-reinforcement member and the second sub-reinforcement member, and a sixth sub-reinforcement member coupled to a lower portion of a fifth lower surface configured on the fifth sub-reinforcement member.

The fifth sub-reinforcement member includes a fourth upper surface, the fifth lower surface disposed to be lower than the fourth upper surface, a fourth intermediate flange configured between the fourth upper surface and the fifth lower surface, a third front flange coupled to an upper surface of a first intermediate flange of the first sub-reinforcement member or a second intermediate flange of the second sub-reinforcement member at a front end portion of the fifth sub-reinforcement member, and a first rear joint extending upward from the vehicle at a rear end portion of the fifth lower surface and coupled to a rear pillar of the vehicle.

The third front flange is coupled to an upper surface of an intermediate flange of a sub-reinforcement member disposed at the frontmost location among the first sub-reinforcement member and the second sub-reinforcement member.

The sixth sub-reinforcement member includes a fifth upper surface, a fourth front flange coupled to an upper surface of the fourth intermediate flange, and a second rear joint coupled to the first rear joint.

An intermediate flange configured on the first sub-reinforcement member or the second sub-reinforcement member is configured to be inclined at a predetermined angle with a ground.

The first sub-reinforcement member or the second sub-reinforcement member is configured as a plurality of members, and the plurality of members are coupled.

According to the side sill reinforcement member of the present disclosure having the above configuration, by forming the space between the sub-reinforcement members fastened to each other to support a collision load in the event of a side collision, the vehicle body can prevent the side sill or the center pillar from penetrating the cabin, thereby reducing injuries to occupants.

In addition, since the space is configured between the sub-reinforcements, the welding tool can be inserted into the space to easily couple the sub-reinforcement members.

Accordingly, by manufacturing the sub-reinforcements using the press processing with easy processing and less cost, it is possible to easily assemble the vehicle and reduce production cost.

In addition, by manufacturing the sub-reinforcement members with the thin metal plate, it is possible to reduce weight, thereby increasing the fuel efficiency or energy efficiency of the vehicle.

Since the space in which the paint can flow during painting is sufficient inside the side sill, the inside of the side sill can be evenly coated with the paint, thereby preventing corrosion.

### BRIEF DESCRIPTION OF THE DRAWINGS

FIG. 1 is a cutout perspective view illustrating a side sill according to the related art.

FIG. 2 is a perspective view illustrating a side sill assembly of a vehicle having a side sill reinforcement member according to one embodiment of the present disclosure.

FIG. 3 is an exploded perspective view illustrating the side sill assembly of the vehicle having the side sill reinforcement member according to one embodiment of the present disclosure.

FIG. 4 is a perspective view illustrating the side sill reinforcement member according to one embodiment of the present disclosure.

FIG. 5 is an exploded perspective view illustrating the side sill reinforcement member according to one embodiment of the present disclosure.

FIG. 6A, FIG. 6B, FIG. 6C, FIG. 6D, FIG. 6E and FIG. 6F are perspective views illustrating first to sixth sub-reinforcement members in the side sill reinforcement member according to one embodiment of the present disclosure.

FIG. 7 is a schematic view illustrating a coupling relationship between the first sub-reinforcement member and a second sub-reinforcement member in the side sill reinforcement member according to one embodiment of the present disclosure.

FIG. 8 is a cross-sectional view of a side sill assembly of the vehicle having the side sill reinforcement member according to one embodiment of the present disclosure.

FIG. 9 is a cross-sectional view along line B-B in FIG. 8.

FIG. 10 is a schematic view illustrating a coupling relationship between a first sub-reinforcement member and a second sub-reinforcement member in a side sill reinforcement member according to another embodiment of the present disclosure.

FIG. 11 is a schematic view illustrating an example in which a sub-reinforcement member is provided as a plurality of members in a side sill reinforcement member according to still another embodiment of the present disclosure.

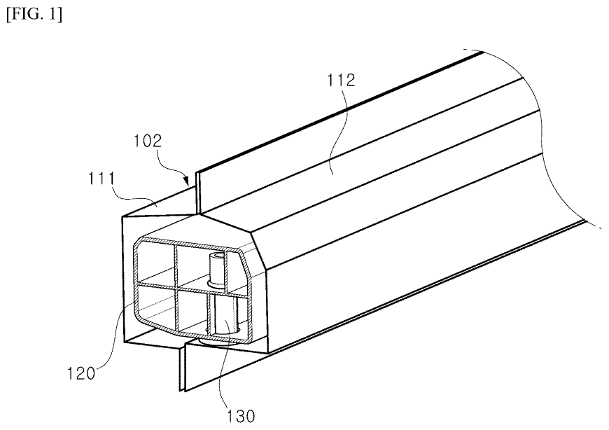

### DESCRIPTION OF SPECIFIC EMBODIMENTS

Hereinafter, a side sill reinforcement member for a side sill of a vehicle according to the present disclosure will be described in detail with reference to the accompanying drawings.

In a side sill reinforcement member for a side sill of a vehicle according to the present disclosure, a first sub-reinforcement member 21 and a second sub-reinforcement member 22 are disposed as a plurality of members alternately in a longitudinal direction of the vehicle, a part of the first sub-reinforcement member 21 is disposed above the second sub-reinforcement member 22, the other part of the first sub-reinforcement member 21 is disposed under the second sub-reinforcement member 22, a front end portion of the first sub-reinforcement member 21 is coupled to an upper portion in the middle of the second sub-reinforcement member 22, and a rear end portion of the first sub-reinforcement member 21 is coupled to a lower portion in the middle of the second sub-reinforcement member 22, and the side sill reinforcement member for a side sill of a vehicle is mounted inside a side sill 2 of the vehicle.

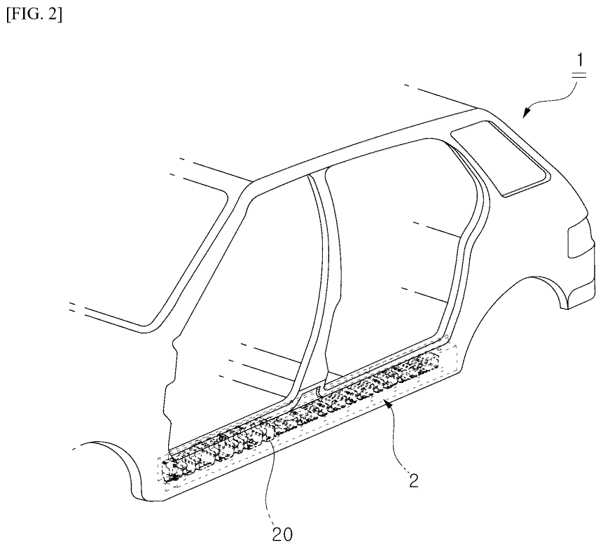

As illustrated in FIGS. 2 and 3, the side sill 2 of the vehicle 1 includes a side sill inner 11 configured convexly inward from the vehicle 1 and a side sill outer 12 configured convexly outward from the vehicle 1.

Upper and lower ends of the side sill inner 11 and the side sill outer 12 are coupled to form a hollow structure in the longitudinal direction of the vehicle 1, thereby forming a structure of a lower portion of the side surface of the vehicle 1.

Front, middle, and rear ends of the side sill 2 are connected to a front pillar, a center pillar, and a rear pillar of the vehicle 1, respectively.

Meanwhile, in a vehicle, such as a multi-purpose vehicle (MPV), a sliding door may be installed using the side sill 2. That is, a guide for guiding the sliding of the sliding door to be parallel to the side sill 2, and a cross-sectional area of the side sill 2 is reduced so that occupants easily get on and off the vehicle. Accordingly, it is difficult to apply a reinforcement member configured of an aluminum alloy material to the inside of the side sill.

Accordingly, in the present disclosure, a plurality of sub-reinforcement members disposed in the longitudinal direction of the vehicle 1 are coupled to form a side sill reinforcement member 12.

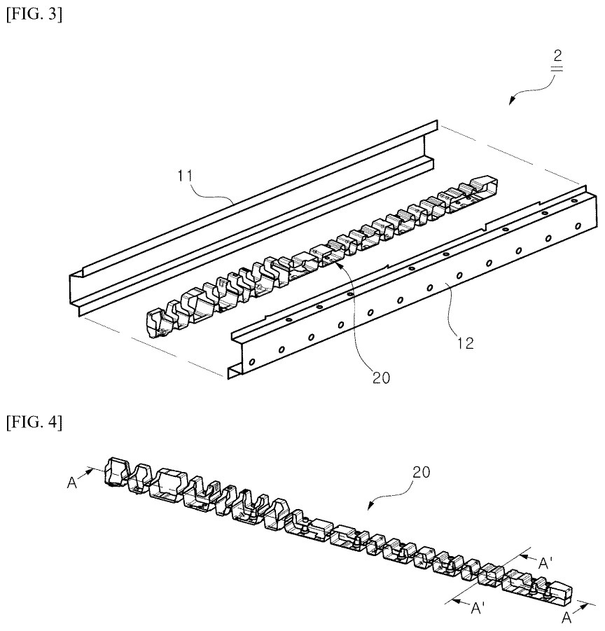

An example of the side sill reinforcement member 12 of a vehicle according to the present disclosure is illustrated in FIGS. 2 to 5.

The side sill reinforcement member 12 according to the present disclosure is configured by arranging a plurality of sub-reinforcement members 21 and 22 in the longitudinal direction of the vehicle and fastening the plurality of the sub-reinforcement members 21 and 22.

The plurality of sub-reinforcement members 21 and 22 have a repeated structure in which a first sub-reinforcement member 21 and the second sub-reinforcement member 22 have upper surfaces 21a and 22a and lower surfaces 21b and 22b configured in the longitudinal direction of the vehicle 1, a front end portion of the second sub-reinforcement member 22 is fastened to the middle of the first sub-reinforcement member 21, and a rear end portion of the first sub-reinforcement member 21 is fastened to the middle of the second sub-reinforcement member 22.

The first sub-reinforcement member 21 and the second sub-reinforcement member 22 are fastened so that a cylindrical structure disposed in the width direction of the vehicle 1 is configured between the upper surfaces 21a and 22a and the lower surfaces 21b and 22b.

The side sill reinforcement member 20 is provided as a plurality of members disposed by alternating the first sub-reinforcement member 21 and the second sub-reinforcement member 22, and the first sub-reinforcement member 21 and the second sub-reinforcement member 22 are coupled to form a basic structure of the side sill reinforcement member 20.

A part of the first sub-reinforcement member 21 is disposed above the second sub-reinforcement member 22, the other part of the first sub-reinforcement member 21 is disposed under another second sub-reinforcement member 22 disposed in the longitudinal direction of the vehicle with respect to the second sub-reinforcement member, the front end portion of the first sub-reinforcement member 21 is coupled to the upper portion in the middle of the second sub-reinforcement member 22, and the rear end portion of the first sub-reinforcement member 21 is coupled to the lower portion in the middle of the another second sub-reinforcement member 22.

A third sub-reinforcement member 23 and a fourth sub-reinforcement member 24 are coupled to a front end portion of an assembly of the first sub-reinforcement member 21 and the second sub-reinforcement member 22 to form a front portion of the side sill reinforcement member 20. In addition, a fifth sub-reinforcement member 25 and a sixth sub-reinforcement member 26 are coupled to a rear end portion of the assembly of the first sub-reinforcement member 21 and the second sub-reinforcement member 22 to form a rear portion of the side sill reinforcement member 20.

The first sub-reinforcement member 21 to the sixth sub-reinforcement member 26 that constitute the side sill reinforcement member 20 are configured by a press processing with easy processing and are coupled. The first sub-reinforcement member 21 to the sixth sub-reinforcement member 26 are coupled through welding, but are coupled through adhering through an adhesive, fastening using a fastening means, such as a bolt, etc.

First, structures of the first sub-reinforcement member 21 and the second sub-reinforcement member 22 will be described as follows.

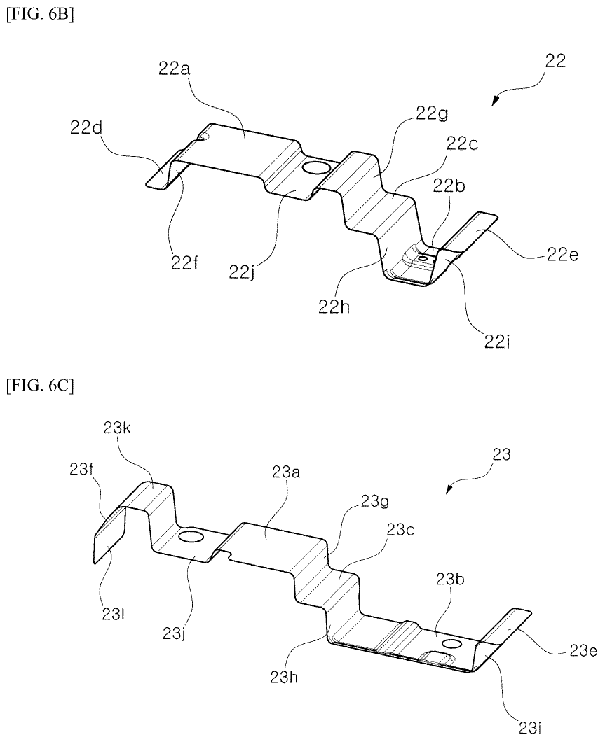

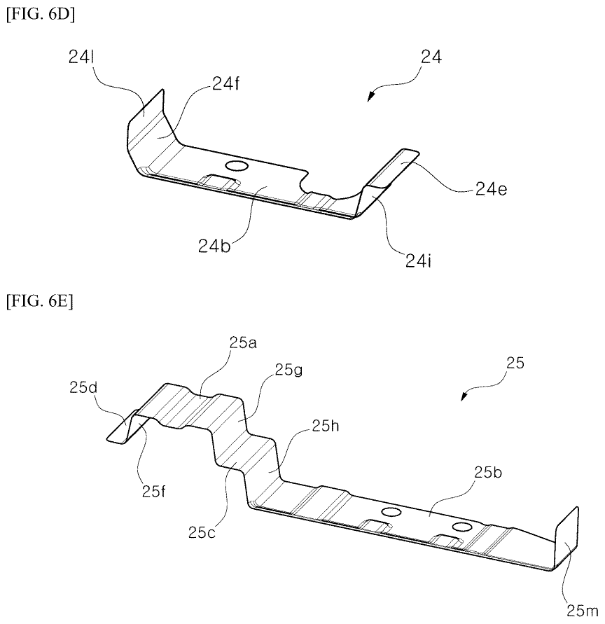

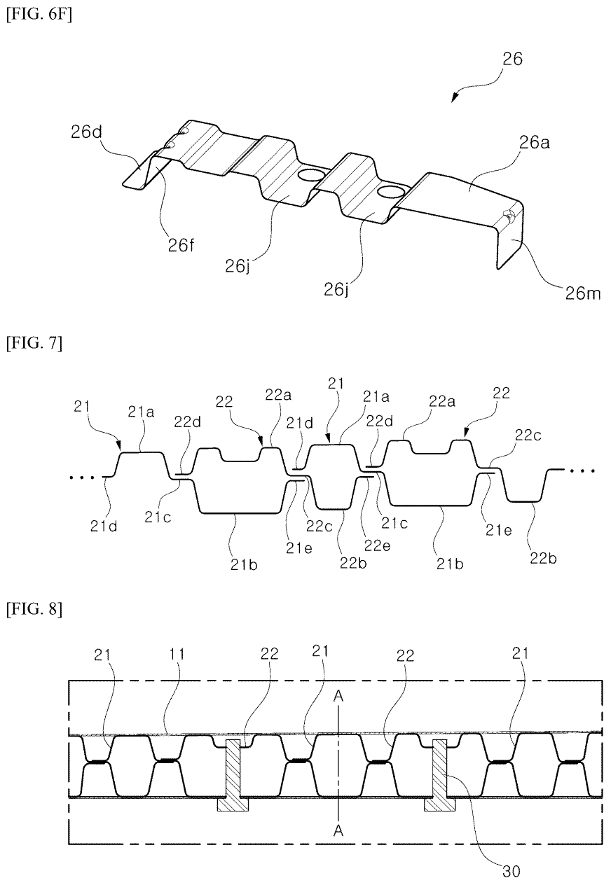

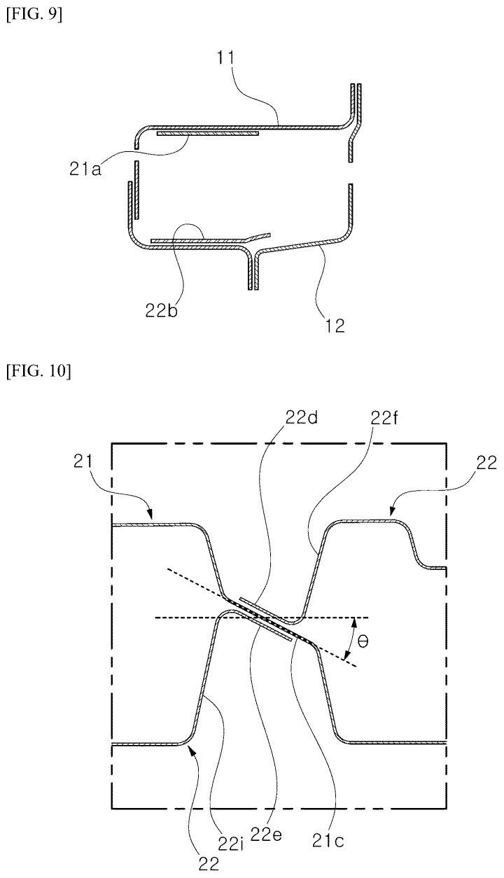

The first sub-reinforcement member 21 is illustrated in FIG. 6A.

The first sub-reinforcement member 21 has a first upper surface 21a disposed to be higher than front and rear end portions thereof, and a first lower surface 21b disposed to be lower than the front and rear end portions and disposed at a rear of the vehicle further than the first upper surface 21a. The first upper surface 21a is coupled to an inner upper surface of the side sill inner 11 or an inner upper surface of the side sill outer 12. The first lower surface 21b is coupled to an inner lower surface of the side sill inner 11 or an inner lower surface of the side sill outer 12.

The first sub-reinforcement member 21 has a first front flange 21d and a first rear flange 21e configured to extend from the front and rear end portions thereof in the longitudinal direction of the vehicle, respectively.

In addition, the first sub-reinforcement member 21 has a first intermediate flange 21c configured to extend between the first upper surface 21a and the first lower surface 21b in the longitudinal direction of the vehicle.

The first front flange 21d and the first upper surface 21a are connected by a first upper front connection portion 21f, and the first upper surface 21a and the first intermediate flange 21c are connected by a first upper rear connection portion 21g.

The first intermediate flange 21c and the first lower surface 21b are connected by a first lower front connection portion 21h, and the first lower surface 21b and the first rear flange 21e are connected by a first lower rear connection portion 21i.

The first sub-reinforcement member 21 has a convex shape configured with respect to the first upper surface 21a and a concave shape configured with respect to the first lower surface 21b, which are configured in the longitudinal direction of the vehicle.

The second sub-reinforcement member 22 is illustrated in FIG. 6B.

The second sub-reinforcement member 22 is configured in a similar shape to the first sub-reinforcement member 21.

The second sub-reinforcement member 22 has a second upper surface 22a disposed to be higher than front and rear end portions thereof, and a second lower surface 22b disposed to be lower than the front and rear end portions and disposed at a rear of the vehicle further than the second upper surface 22a. Like the first upper surface 21a, the second upper surface 22a is also coupled to the inner upper surface of the side sill inner 11 or the inner upper surface of the side sill outer 12. In addition, the second lower surface 22b is also coupled to the inner lower surface of the side sill inner 11 or the inner lower surface of the side sill outer 12.

In addition, the second sub-reinforcement member 22 has a second front flange 22d and a second rear flange 22e configured to extend from the front and rear end portions thereof in the longitudinal direction of the vehicle, respectively.

In addition, the second sub-reinforcement member 22 has a second intermediate flange 22c configured to extend between the second upper surface 22a and the second lower surface 22b in the longitudinal direction of the vehicle.

The second front flange 22d and the second upper surface 22a are connected by a second upper front connection portion 22f, and the second upper surface 22a and the second intermediate flange 22c are connected by a second upper rear connection portion 22g.

In addition, the second intermediate flange 22c and the second lower surface 22b are connected by a second lower front connection portion 22h, and the second lower surface 22b and the second rear flange 22e are connected by a second lower rear connection portion 22i.

Like the first sub-reinforcement member 21, the second sub-reinforcement member 22 also has a convex shape configured with respect to the second upper surface 22a and a concave shape configured with respect to the second lower surface 22b, which are configured in the longitudinal direction of the vehicle.

A coupling relationship between the first sub-reinforcement member 21 and the second sub-reinforcement member 22, which form the basic structure of the side sill reinforcement member 20, is illustrated in FIG. 7.

The first sub-reinforcement member 21 and the second sub-reinforcement member 22 are each provided as a plurality of members, and the first sub-reinforcement member 21 and the second sub-reinforcement member 22 are disposed alternately in the longitudinal direction of the vehicle.

Referring to the coupling relationship between the first sub-reinforcement member 21 and the second sub-reinforcement member 22, the second front flange 22d of the another second sub-reinforcement member 22 is coupled to an upper portion of the first intermediate flange 21c of the first sub-reinforcement member 21, and the first rear flange 21e of the first sub-reinforcement member 21 is coupled to a lower surface of the another second intermediate flange 22c.

In addition, the second rear flange 22e of the second sub-reinforcement member 22 is coupled to a lower portion of the first intermediate flange 21c configured on another first sub-reinforcement member 21 disposed in the longitudinal direction of the vehicle with respect to the first sub-reinforcement member 21.

The second front flange 22d and the second rear flange 22e are coupled to the upper surface and the lower surface of the first intermediate flange 21c, respectively, and the second front flange 22d and the second rear flange 22e are also coupled to the upper surface and the lower surface of the second intermediate flange 22c, respectively, thereby increasing a thickness and increasing rigidity.

Such a coupling structure is repeated along the length of the vehicle 1 to form a basic structure that becomes the middle portion of the side sill reinforcement member 20.

Accordingly, the first sub-reinforcement member 21 and the second sub-reinforcement member 22 are coupled so that the first upper surface 21a is disposed above the second lower surface 22b and the second upper surface 22a is disposed above the first lower surface 21b.

A space is configured between the first upper surface 21a of the first sub-reinforcement member 21 and the second lower surface 22b of the second sub-reinforcement member 22 so that a welding tool is inserted through the space, and thus the side sill reinforcement member 20 is welded to the side sill inner 11 or the side sill outer 12. In addition, a space is also configured between the second upper surface 22a of the second sub-reinforcement member 22 and the first lower surface 21b of the first sub-reinforcement member 21.

Referring to FIGS. 6A and 6B, a first concave portion 22j is formed with a second pipe nut hole 22k corresponding to a first pipe nut hole 21k formed in the first lower surface 21b through which the pipe nut 30 passes. The first concave portion 22j is configured to be lower than the first upper surface 21a or the second upper surface 22a is configured in the first upper surface 21a or the second upper surface 22a. For example, an example in which the first concave portion 22j is configured in the second upper surface 22a is illustrated in FIGS. 6B and 7. The pipe nut 30 may be used both to mount a battery of an electric vehicle and to connect the first sub-reinforcement member 21 to the second sub-reinforcement member 22, thereby increasing the rigidity of the side sill reinforcement member 20.

The side sill reinforcement member 20 has the third sub-reinforcement member 23 and the fourth sub-reinforcement member 24 coupled to the front end portion of the assembly of the first sub-reinforcement member 21 and the second sub-reinforcement member 22 to form the front portion of the side sill reinforcement member 20. In addition, the side sill reinforcement member 20 has the fifth sub-reinforcement member 25 and the sixth sub-reinforcement member 26 coupled to the rear end portion of the assembly of the first sub-reinforcement member 21 and the second sub-reinforcement member 22 to form the rear portion of the side sill reinforcement member 20.

The third sub-reinforcement member 23 is coupled to one of the first sub-reinforcement member 21 and the second sub-reinforcement member 22, which is disposed at the frontmost location, at the front end portion of the assembly of the first sub-reinforcement member 21 and the second sub-reinforcement member 22.

The fourth sub-reinforcement member 24 is coupled to a lower portion of the third sub-reinforcement member 23.

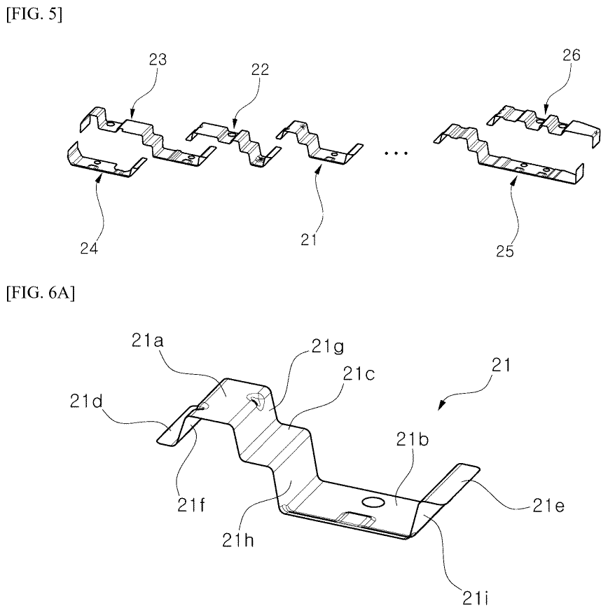

For example, FIG. 5 illustrates an example in which the third sub-reinforcement member 23 is coupled to the second sub-reinforcement member 22 disposed at the frontmost location, and the fourth sub-reinforcement member 24 is coupled to a lower portion of the third sub-reinforcement member 23.

The fifth sub-reinforcement member 25 is coupled to one of the first sub-reinforcement member 21 and the second sub-reinforcement member 22, which is disposed at the rearmost location, at the rear end portion of the assembly of the first sub-reinforcement member 21 and the second sub-reinforcement member 22.

The sixth sub-reinforcement member 26 is coupled to an upper portion of the fifth sub-reinforcement member 25.

FIG. 5 illustrates an example in which the fifth sub-reinforcement member 25 is coupled to the first sub-reinforcement member 21 disposed at the rearmost location, and the sixth sub-reinforcement member 26 is coupled to an upper portion of the fifth sub-reinforcement member 25.

The third sub-reinforcement member 23 is illustrated in FIG. 6C.

The third sub-reinforcement member 23 includes a third upper surface 23a, a third lower surface 23b disposed to be lower than the third upper surface 23a, a third intermediate flange 23c configured between the third upper surface 23a and the third lower surface 23b, a third rear flange 23e coupled to the lower surface of the first intermediate flange 21c of the first sub-reinforcement member 21 or the second intermediate flange 22c of the second sub-reinforcement member 22 at a rear end portion of the third sub-reinforcement member 23, a first front joint 23l coupled to the front pillar of the vehicle at a front end portion of the third sub-reinforcement member 23, and a support 23k coupled to the inner upper surface of the side sill 2 between the first front joint 23l and the third upper surface 23a.

The third upper surface 23a is configured in the longitudinal direction of the vehicle. The third upper surface 23a is coupled to the inner upper surface of the side sill inner 11 or the inner upper surface of the side sill outer 12.

The third lower surface 23b is disposed to be lower than the third upper surface 23a and disposed at the rear of the vehicle from the third upper surface 23a. The third lower surface 23b is coupled to the inner lower surface of the side sill inner 11 or the inner lower surface of the side sill outer 12.

The third intermediate flange 23c is configured between the third upper surface 23a and the third lower surface 23b in the longitudinal direction of the vehicle. The third intermediate flange 23c is connected to the third upper surface 23a through the third upper rear connection portion 23g and to the third lower surface 23b through the third lower front connection portion 23h.

The third intermediate flange 23c is configured so that the third sub-reinforcement member 23 is coupled to the first sub-reinforcement member 21 or the second sub-reinforcement member 22. The front flanges 21d and 22d of the sub-reinforcement members 21 and 22 among the first sub-reinforcement member 21 and the second sub-reinforcement member 22, which are disposed at the frontmost location, are coupled to an upper portion of the third intermediate flange 23c. That is, the first front flange 21d or the second front flange 22d is coupled to the upper portion of the third intermediate flange 23c so that the third sub-reinforcement member 23 is coupled to the first sub-reinforcement member 21 or the second sub-reinforcement member 22.

The third rear flange 23e is configured at the rear end portion of the third sub-reinforcement member 23. The third rear flange 23e is configured in the longitudinal direction of the vehicle, and the third rear flange 23e is connected to the third lower surface 23b through the third lower rear connection portion 23i.

The third rear flange 23e is configured so that the third sub-reinforcement member 23 is coupled to the first sub-reinforcement member 21 or the second sub-reinforcement member 22. The third rear flange 23e is coupled to the lower surfaces of the intermediate flanges 21c and 22c of the sub-reinforcement members 21 and 22 disposed at the frontmost locations among the first sub-reinforcement member 21 and the second sub-reinforcement member 22. That is, the third rear flange 23e is coupled to the lower surface of the first intermediate flange 21c or the second intermediate flange 22c so that the third sub-reinforcement member 23 is coupled to the first sub-reinforcement member 21 or the second sub-reinforcement member 22.

The first front joint 23l is configured at the front end portion of the third sub-reinforcement member 23. The first front joint 23l is configured in the height direction of the vehicle and coupled to the front pillar of the vehicle or the second front joint 24l.

The support 23k is coupled to the inner upper surface of the side sill 2 at the front of the third sub-reinforcement member 23. For example, the support 23k may be coupled to the inner upper surface of the side sill inner 11. The support 23k is connected to the first front joint 23l through the third upper front connection portion 23f.

The third sub-reinforcement member 23 may have a second concave portion 23j through which the pipe nut 30 passes and which is configured to be lower than the third upper surface 23a.

The fourth sub-reinforcement member 24 is illustrated in FIG. 6D.

The fourth sub-reinforcement member 24 includes a fourth lower surface 24b, a second front joint 24l disposed in front of the fourth lower surface 24b and coupled to the first front joint 23l, and a fourth rear flange 24e disposed behind the fourth lower surface 24b, extending to the rear of the vehicle, and coupled to a lower surface of the third intermediate flange 23c.

The fourth lower surface 24b is disposed under the third upper surface 23a. A lower surface of the fourth lower surface 24b is coupled to the inner lower surface of the side sill inner 11 or the inner lower surface of the side sill outer 12.

The second front joint 24l is connected to the fourth lower surface 24b through the fourth upper front connection portion 24f. The second front joint 24l is configured in the height direction of the vehicle and coupled to the front pillar of the vehicle or the first front joint 23l. The first front joint 23l and the second front joint 24l are disposed to overlap each other and coupled together to the front pillar. Accordingly, a front end portion of the side sill reinforcement member 20 is coupled to the front pillar.

The fourth rear flange 24e is disposed at the rear of the fourth sub-reinforcement member 24 and extends to the rear of the vehicle. The fourth rear flange 24e is connected to the fourth lower surface 24b through the fourth lower rear connection portion 24i. The fourth rear flange 24e forms a rear end portion of the fourth sub-reinforcement member 24 and is connected to the third intermediate flange 23c so that the rear end portion of the fourth sub-reinforcement member 24 is coupled to the middle of the third sub-reinforcement member 23.

The fourth sub-reinforcement member 24 is configured in a concave shape and coupled to the lower portion of the third upper surface 23a of the third sub-reinforcement member 23. By coupling the fourth sub-reinforcement member 24 to the lower portion of the third sub-reinforcement member 23, a space is also configured by the third upper surface 23a and the fourth lower surface 24b at the front end portion of the side sill reinforcement member 20 to form a cylindrical structure disposed in the width direction of the vehicle 1 so that a welding tool is inserted into the cylindrical structure.

The fifth sub-reinforcement member 25 is illustrated in FIG. 6E.

The fifth sub-reinforcement member 25 includes a fourth upper surface 25a, a fifth lower surface 25b disposed to be lower than the fourth upper surface 25a, a fourth intermediate flange 25c configured between the fourth upper surface 25a and the fifth lower surface 25b, a third front flange 25d coupled to an upper surface of the first intermediate flange 21c of the first sub-reinforcement member 21 or the second intermediate flange 22c of the second sub-reinforcement member 22 at a front end portion of the fifth sub-reinforcement member 25, and a first rear joint 25m coupled to a rear pillar of the vehicle at a rear end portion of the fifth sub-reinforcement member 25.

The fourth upper surface 25a is configured in the longitudinal direction of the vehicle. The fourth upper surface 25a is coupled to the inner upper surface of the side sill inner 11 or the inner upper surface of the side sill outer 12.

The fifth lower surface 25b is disposed to be lower than the fourth upper surface 25a and disposed at the rear of the vehicle from the fourth upper surface 25a. The fifth lower surface 25b is coupled to the inner lower surface of the side sill inner 11 or the inner lower surface of the side sill outer 12.

The fourth intermediate flange 25c is configured between the fourth upper surface 25a and the fifth lower surface 25b in the longitudinal direction of the vehicle. The fourth intermediate flange 25c is connected to the fourth upper surface 25a through the fourth upper rear connection portion 25g and connected to the fifth lower surface 25b through the fourth lower front connection portion 25h.

The third front flange 25d is coupled to the upper surface of the first intermediate flange 21c of the first sub-reinforcement member 21 or the second intermediate flange 22c of the second sub-reinforcement member 22 at the front end portion of the fifth sub-reinforcement member 25. The third front flange 25d is coupled to the upper surfaces of the intermediate flanges 21c and 22c of the sub-reinforcement members 21 and 22 disposed at the rearmost locations among the first sub-reinforcement member 21 and the second sub-reinforcement member 22 so that the fifth sub-reinforcement member 25 is coupled to the sub-reinforcement members 21 and 22 disposed at the rearmost locations among the first sub-reinforcement member 21 and the second sub-reinforcement member 22.

The first rear joint 25m is configured in the height direction of the vehicle and coupled to the rear pillar of the vehicle or the second rear joint 26m to be described below at the rear end portion of the fifth sub-reinforcement member 25. The first rear joint 25m extends upward from the vehicle at the rear end portion of the fifth lower surface 25b to an upper portion of the vehicle and is coupled to the rear pillar of the vehicle or the second rear joint 26m.

The sixth sub-reinforcement member 26 is illustrated in FIG. 6F.

The sixth sub-reinforcement member 26 includes a fifth upper surface 26a, a fourth front flange 26d coupled to the upper surface of the fourth intermediate flange 25c, and the second rear joint 26m connected to the first rear joint 25m.

The fifth upper surface 26a is configured in the longitudinal direction of the vehicle. The fifth upper surface 26a is disposed above the fifth lower surface 25b of the fifth sub-reinforcement member 25 to form a space therebetween. The fifth upper surface 26a is coupled to the inner upper surface of the side sill inner 11 or the inner upper surface of the side sill outer 12.

The fourth front flange 26d is configured at a front end portion of the sixth sub-reinforcement member 26 and coupled to the upper surface of the fourth intermediate flange 25c. The fourth front flange 26d is connected to the fifth upper surface 26a through the sixth upper front connection portion 26f. The fourth front flange 26d is coupled to the upper surface of the fourth intermediate flange 25c so that the front end portion of the sixth sub-reinforcement member 26 is coupled to the fifth sub-reinforcement member 25. The third front flange 25d is connected to the fourth upper surface 25a through the fourth upper front connection portion 25f.

The second rear joint 26m is configured in the height direction of the vehicle at a rear end portion of the fifth upper surface 26a. The second rear joint 26m extends downward from the rear end portion of the fifth upper surface 26a. The first rear joint 25m and the second rear joint 26m are disposed to overlap each other and coupled together to the rear pillar. Accordingly, the rear end portion of the side sill reinforcement member 20 is coupled to the rear pillar.

The sixth sub-reinforcement member 26 may have a third concave portion 26j through which the pipe nut 30 passes and which is configured to be lower than the fifth upper surface 26a.

As the side sill reinforcement member 20 is configured by coupling a plurality of the sub-reinforcement members, a space is configured to form a cylindrical structure in the width direction of the vehicle, and thus the side sill reinforcement member 20 supports a collision load, thereby reducing the deformation of the side sill 2. Accordingly, the side sill 2 and the front pillar, the center pillar, and the rear pillar that are connected to the side sill 2 can be prevented from being deformed to enter the vehicle, thereby reducing injuries to the occupants.

FIG. 10 illustrates a side sill reinforcement member 12 according to another embodiment of the present disclosure.

The flanges configured on the sub-reinforcement members 21, 22, 23, 24, 25, and 26 constituting the side sill reinforcement member 20 are configured to be inclined at a predetermined angle θ with respect to the horizontal plane in advance.

For example, referring to FIG. 10, the first intermediate flange 21c may be configured to be inclined, and the second front flange 22d and the second rear flange 22e, which are respectively coupled to the upper surface and the lower surface of the first intermediate flange 21c, may also be configured to be inclined at corresponding angles.

In this way, by forming the flanges to be inclined, a portion in which the flanges are coupled may be configured to have an acute angle, thereby increasing the rigidity of the flanges. For example, when the first intermediate flange 21c is configured to be inclined, the second front flange 22d forms an acute angle with the second upper front connection portion 22f, and the second rear flange 22e forms an acute angle with the second lower rear connection portion 22i. Accordingly, it is possible to increase the rigidity of the front and rear end portions of the second sub-reinforcement member 22.

Likewise, the second intermediate flange 22c, the third intermediate flange 23c, and the fourth intermediate flange 25c may be configured to be inclined, and the flanges coupled thereto may also be configured to be inclined accordingly.

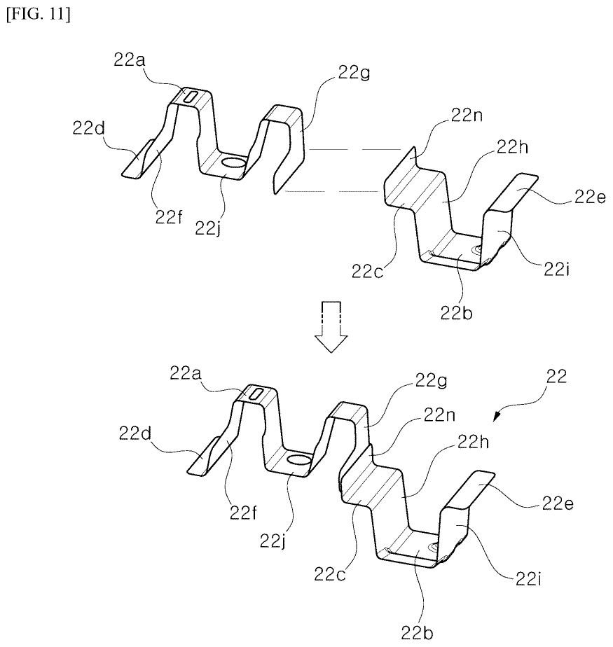

FIG. 11 illustrates a side sill reinforcement member 12 according to still another embodiment of the present disclosure.

In the present embodiment, one sub-reinforcement member may be configured as a plurality of members.

For example, as illustrated in FIG. 11, the second sub-reinforcement member 22 is configured as a plurality of members, and when each member is coupled, a fastening portion 22n is configured on one member to couple the plurality of members through welding, adhering, fastening means, etc. using the fastening portion 22n.

Since the portions coupled through the fastening portion 22n have a thicker cross sections than other portions, it is possible to increase rigidity.

FIG. 11 illustrates the second sub-reinforcement member 22, but the first sub-reinforcement member 21, and the third sub-reinforcement member 23 to the sixth sub-reinforcement member 26 may be configured as a plurality of members, and the plurality of members are configured to be coupled.

What is claimed is:

1. A side sill reinforcement member for a side sill of a vehicle, the side sill reinforcement member comprising,
a first sub-reinforcement member, and a second sub-reinforcement member,
wherein the first sub-reinforcement member and the second sub-reinforcement member are disposed as a plurality of members that alternate in a longitudinal direction of the vehicle,
wherein a portion of the first sub-reinforcement member is disposed above the second sub-reinforcement member, and another portion of the first sub-reinforcement member is disposed under another second sub-reinforcement member disposed in the longitudinal direction of the vehicle with respect to the second sub-reinforcement member, and
wherein the plurality of members that alternate in the longitudinal direction of the vehicle are mounted inside a side sill of the vehicle.

2. The side sill reinforcement member of claim 1, wherein a front end portion of the first sub-reinforcement member is coupled to an upper portion in the middle of the second sub-reinforcement member, and a rear end portion of the first sub-reinforcement member is coupled to a lower portion in the middle of the another second sub-reinforcement member.

3. The side sill reinforcement member of claim 1, wherein the first sub-reinforcement member and the second sub-reinforcement member are repeatedly coupled in the longitudinal direction of the vehicle so that a space is repeatedly configured between the first sub-reinforcement member and the second sub-reinforcement member in the longitudinal direction of the vehicle.

4. The side sill reinforcement member of claim 1, wherein the first sub-reinforcement member has a first upper surface disposed to be higher than front and rear end portions thereof, and a first lower surface disposed to be lower than the front and rear end portions and disposed at a rear of the vehicle further than the first upper surface,
the second sub-reinforcement member has a second upper surface disposed to be higher than front and rear end portions thereof, and a second lower surface disposed to be lower than the front and rear end portions and disposed at the rear of the vehicle further than the second upper surface, and
the first sub-reinforcement member and the second sub-reinforcement member are coupled so that the first upper surface is disposed above the second lower surface, and the second upper surface is disposed above the first lower surface.

5. The side sill reinforcement member of claim 4, wherein the first sub-reinforcement member has a first front flange and a first rear flange, which extend in the longitudinal direction of the vehicle, configured at the front and rear end portions thereof, respectively, and
the second sub-reinforcement member has a second front flange and a second rear flange configured at the front and rear end portions thereof, respectively, the second front flange and the second rear flange extending in the longitudinal direction of the vehicle.

6. The side sill reinforcement member of claim 5,
wherein the first sub-reinforcement member has a first intermediate flange configured between the first upper surface and the first lower surface, the first intermediate flange extending in the longitudinal direction of the vehicle, and
wherein the second sub-reinforcement member has a second intermediate flange configured between the second upper surface and the second lower surface, the second intermediate flange extending in the longitudinal direction of the vehicle.

7. The side sill reinforcement member of claim 6, wherein the first front flange is coupled to an upper portion of the second intermediate flange, and the second front flange is coupled to an upper portion of the first intermediate flange.

8. The side sill reinforcement member of claim 6,
wherein the first rear flange is coupled to a lower portion of the second intermediate flange configured on the another second sub-reinforcement member, and
wherein the second rear flange is coupled to a lower portion of the first intermediate flange configured on another first sub-reinforcement member disposed in the longitudinal direction of the vehicle with respect to the first sub-reinforcement member.

9. The side sill reinforcement member of claim 4, wherein a concave portion through which a pipe nut passes and which is configured to be lower than the first upper surface or the second upper surface is configured in the first upper surface or the second upper surface.

10. The side sill reinforcement member of claim 1, further comprising:
a third sub-reinforcement member coupled to one of the first sub-reinforcement member and the second sub-reinforcement member, which is disposed at a frontmost location, at a front end portion of an assembly of the first sub-reinforcement member and the second sub-reinforcement member; and
a fourth sub-reinforcement member coupled to a lower portion of a third upper surface configured on the third sub-reinforcement member.

11. The side sill reinforcement member of claim 10, wherein the third sub-reinforcement member includes:
the third upper surface;
a third lower surface disposed to be lower than the third upper surface;
a third intermediate flange configured between the third upper surface and the third lower surface;
a third rear flange coupled to a lower surface of a first intermediate flange of the first sub-reinforcement member or a second intermediate flange of the second sub-reinforcement member at a rear end portion of the third sub-reinforcement member;
a first front joint coupled to a front pillar of the vehicle at a front end portion of the third sub-reinforcement member; and
a support coupled to an inner upper surface of the side sill between the first front joint and the third upper surface.

12. The side sill reinforcement member of claim 11,
wherein a front flange of a sub-reinforcement member disposed at the frontmost location among the first sub-reinforcement member and the second sub-reinforcement member is coupled to an upper portion of the third intermediate flange, and
wherein the third rear flange is coupled to a lower surface of an intermediate flange of a sub-reinforcement member disposed at the frontmost location among the first sub-reinforcement member and the second sub-reinforcement member.

13. The side sill reinforcement member of claim 11, wherein the fourth sub-reinforcement member includes:
a fourth lower surface;
a second front joint disposed in front of the fourth lower surface and coupled to the first front joint; and
a fourth rear flange disposed behind the fourth lower surface, extending to a rear of the vehicle, and coupled to a lower surface of the third intermediate flange.

14. The side sill reinforcement member of claim 1, further comprising:
a fifth sub-reinforcement member coupled to one of the first sub-reinforcement member and the second sub-reinforcement member, which is disposed at a frontmost location, at a rear end portion of an assembly of the first sub-reinforcement member and the second sub-reinforcement member; and
a sixth sub-reinforcement member coupled to a lower portion of a fifth lower surface configured on the fifth sub-reinforcement member.

15. The side sill reinforcement member of claim 14, wherein the fifth sub-reinforcement member includes:
a fourth upper surface;
the fifth lower surface disposed to be lower than the fourth upper surface;
a fourth intermediate flange configured between the fourth upper surface and the fifth lower surface;
a third front flange coupled to an upper surface of a first intermediate flange of the first sub-reinforcement member or a second intermediate flange of the second sub-reinforcement member at a front end portion of the fifth sub-reinforcement member; and
a first rear joint extending upward from the vehicle at a rear end portion of the fifth lower surface and coupled to a rear pillar of the vehicle.

16. The side sill reinforcement member of claim 15, wherein the third front flange is coupled to an upper surface of an intermediate flange of a sub-reinforcement member disposed at the frontmost location among the first sub-reinforcement member and the second sub-reinforcement member.

17. The side sill reinforcement member of claim 15, wherein the sixth sub-reinforcement member includes:
a fifth upper surface;
a fourth front flange coupled to an upper surface of the fourth intermediate flange; and
a second rear joint coupled to the first rear joint.

18. The side sill reinforcement member of claim 1, wherein an intermediate flange configured on the first sub-reinforcement member or the second sub-reinforcement member is configured to be inclined at a predetermined angle with a ground.

19. The side sill reinforcement member of claim 1, wherein the first sub-reinforcement member or the second sub-reinforcement member is configured as a plurality of members, and the plurality of members are coupled.
